(19) United States
(12) Patent Application Publication
(10) Pub. No.: US 2007/0104058 A1
(43) Pub. Date: May 10, 2007

(54) Information recording medium, information recording device and method, information recording/reproducing device and method, and computer program

(76) Inventors: Kunihiko Horikawa, Saitama (JP); Kazuo Kuroda, Saitama (JP); Toshio Suzuki, Saitama (JP); Shoji Taniguchi, Saitama (JP); Eiji Muramatsu, Saitama (JP); Masahiro Kato, Saitama (JP)

Correspondence Address: YOUNG & THOMPSON, 745 SOUTH 23RD STREET, 2ND FLOOR, ARLINGTON, VA, 22202, US

(21) Appl. No.: 10/574,353

(22) PCT Filed: Sep. 28, 2004
(86) PCT No.: PCT/JP04/14150

§ 371 Date: Jul. 26, 2006

(30) Foreign Application Priority Data
Oct. 3, 2003 (JP) 2003-345765

(51) Int. Cl. G11B 7/12

(52) U.S. Cl. 369/47.53

(57) ABSTRACT

An information recording medium (100) is provided with: a recording area (106) to record therein record information by irradiating laser light thereto; and a recording control area (103) to record therein control information for controlling a laser power in accordance with a recording position in the recording area.

### TECHNICAL FIELD

The present invention relates to an information recording medium, such as a DVD, an information recording apparatus, such as a DVD recorder, an information recording method, an information recording/reproducing apparatus, an information recording/reproducing method, and a computer program which makes a computer function as the information recording apparatus.

### BACKGROUND ART

In an information recording/reproducing apparatus for recording information onto an information recording medium, such as an optical disc, for example, the optimum laser power of laser light used in a recording operation, for example, is set by an OPC (Optimum Power Calibration) process, depending on the type of the optical disc, the type of the information recording/reproducing apparatus, recording speed and so on. That is, the calibration of the laser power is performed. By this, it is possible to realize an appropriate recording operation. For example, if the optical disc is loaded and a writing command is inputted, data for test writing is recorded into an OPC area, with sequentially changing the light intensity. A so-called test writing process is performed. Then, the data for test writing recorded in this manner is reproduced, and this reproduction result is judged by a predetermined estimation (prediction) standard, to thereby set the optimum laser power. Moreover, it is also possible to set the optimum laser power, by OPC performed simultaneously with an actual recording operation (so-called, running OPC) (refer to a patent document 1).

Patent document 1: Japanese Patent Application Laying Open NO. 2002-76653

### DISCLOSURE OF INVENTION

### Object to be Solved by the Invention

However, since the OPC is generally performed in a predetermined area of the optical disc, there is such a technical problem that the optimum laser power is not always obtained on the entire surface of the optical disc. In addition, since the running OPC is performed with the actual recording, there is such a technical problem that it is not always possible to perform the recording with an appropriate laser power in an area into which the data has not been recorded yet.

In order to solve the above-mentioned conventional problems, it is therefore an object of the present invention to provide an information recording medium, an information recording apparatus, an information recording method, an information recording/reproducing apparatus, and an information recording/reproducing method, which enable record information to be recorded with a more preferable laser power, as well as a computer program which makes a computer function as the information recording apparatus or the information recording/reproducing apparatus.

### MEANS FOR SOLVING THE OBJECT

In order to solve the above object, an information recording medium of the present invention is provided with: a recording area to record therein record information by irradiating laser light thereto; and a recording control area to record therein control information for controlling a laser power in accordance with a recording position in the recording area.

In order to solve the above object, a first information recording apparatus of the present invention is provided with: a recording device for recording record information by irradiating laser light onto the information recording medium of the present invention; and an optimizing device for optimizing a laser power, on the basis of the control information recorded in the recording control area of the information recording medium.

In order to solve the above object, a second information recording apparatus of the present invention is provided with: a first recording device for irradiating laser light onto an information recording medium and for recording record information onto the information recording medium; a control information generating device for obtaining an optimum laser power according to a recording position of the information recording medium and for generating control information which indicates an association between information which represents the recording position and information which represents the optimum laser power; a second recording device for recording the control information generated by the control information generating device; and a controlling device for controlling a laser power of the laser light irradiated onto the information recording medium, on the basis of the control information recorded by the second recording device.

In order to solve the above object, a first information recording method of the present invention is provided with: a recording process of recording record information by irradiating laser light onto the information recording medium of the present invention; and an optimizing process of optimizing a laser power, on the basis of the control information recorded in the recording control area of the information recording medium.

In order to solve the above object, a second information recording method of the present invention is provided with: a first recording process of irradiating laser light onto an information recording medium and of recording record information onto the information recording medium; a control information generating process of obtaining an optimum laser power according to a recording position of the information recording medium and of generating control information which indicates an association between the recording position and information which represents the optimum laser power; a second recording process of recording the control information generated in the control information generating process; and a controlling process of controlling a laser power of the laser light irradiated onto the information recording medium, on the basis of the control information recorded in the second recording process.

In order to solve the above object, a first information recording/reproducing apparatus of the present invention is provided with: the first information recording apparatus of the present invention; and a reproducing device for reproducing the record information recorded on the information recording medium.

In order to solve the above object, a second information recording/reproducing apparatus of the present invention is provided with: the second information recording apparatus of the present invention; and a reproducing device for reproducing the record information recorded on the information recording medium.

In order to solve the above object, a first information recording/reproducing method of the present invention is provided with: the first information recording method of the present invention; and a reproducing process of reproducing the record information recorded on the information recording medium.

In order to solve the above object, a second information recording/reproducing method of the present invention is provided with: the second information recording method of the present invention; and a reproducing process of reproducing the record information recorded on the information recording medium.

In order to solve the above object, a first computer program for record control to control a computer provided for the first information recording apparatus of the present invention, to make the computer function as at least one portion of the recording device and the optimizing device.

In order to solve the above object, a second computer program for record control to control a computer provided for the second information recording apparatus of the present invention, to make the computer function as at least one portion of the recording device, the control information generating device, the second recording device, and the controlling device.

In order to solve the above object, a third computer program for record/reproducing control to control a computer provided for the first information recording/reproducing apparatus of the present invention, to make the computer function as at least one portion of the information recording apparatus and the reproducing device.

In order to solve the above object, a fourth computer program for record/reproducing control to control a computer provided for the second information recording/reproducing apparatus of the present invention, to make the computer function as at least one portion of the information recording apparatus and the reproducing device.

These effects and other advantages of the present invention become more apparent from the following embodiments.

### BRIEF DESCRIPTION OF DRAWINGS

FIG. 1 shows the basic structure of an optical disc which is used for examples of the information recording apparatus of the present invention, wherein the upper part is a substantial plan view showing the optical disc having a plurality of areas and the corresponding lower part is a schematic conceptual view showing a recording area structure in the radial direction.

FIG. 2 is a data structural view conceptually showing the data structure of the optical disc in the example.

FIG. 3 are graphs and a list conceptually showing recording-sensitivity information, recorded on the optical disc in the example.

FIG. 4 is a block diagram conceptually showing the basic structure of a first example according to the information recording apparatus of the present invention.

FIG. 5 is a flowchart showing a flow of the entire recording operation of the information recording apparatus in the first example.

FIG. 6 are graphs conceptually showing a state of correction of a recording laser power.

FIG. 7 is a block diagram conceptually showing the basic structure of a second example according to the information recording apparatus of the present invention.

FIG. 8 is a flowchart showing a flow of the entire recording operation related to a first operation example, in the information recording apparatus in the second example.

FIG. 9 is a graph conceptually showing an aspect of correction of a calibration curve.

FIG. 10 is a graph conceptually showing an aspect of calculating the calibration curve.

FIG. 11 is a list showing one specific example of ROPC data.

FIG. 12 are graphs showing one specific example of a more specific calibration curve.

FIG. 13 is a flowchart showing a flow of the recording operation into a different recording layer related to the first operation example, in the information recording apparatus in the first example.

FIG. 14 is a graph conceptually showing a calculation operation of calculating the calibration curve.

FIG. 15 is a flowchart showing a flow of the recording operation related to a second operation example, in the information recording apparatus in the second example.

FIG. 16 is a flowchart showing a flow of the recording operation into a different recording layer related to the second operation example, in the information recording apparatus in the second example.

### DESCRIPTION OF REFERENCE CODES

1,2 Information recording apparatus
100 Optical disc
103 Recording-sensitivity information
104, 114, 124 Lead-in area
108, 118, 128 Lead-out area
310 Optical pickup
312 RF detector
320 LD driver
326 LPP data detector
400 CPU
410 Comparison device
420 Memory

### BEST MODE FOR CARRYING OUT THE INVENTION

Hereinafter, an explanation will be sequentially given to an information recording medium, an information recording apparatus, an information recording method, an information recording/reproducing apparatus, an information recording/reproducing method, and a computer program, according to embodiments of the present invention, as being a best mode for carrying out the invention.

(Embodiment of Information Recording Medium)

An embodiment of the information recording medium of the present invention is provided with: a recording area to record therein record information by irradiating laser light thereto; and a recording control area to record therein control information for controlling a laser power in accordance with a recording position in the recording area.

According to the embodiment of the information recording medium of the present invention, it is possible to record various record information, which includes contents, such as video record information and music record information, or data information for a computer or the like, for example, in the recording area.

Particularly in the embodiment, the recording control area is provided, and the control information for controlling the laser power in accordance with the recording position is recorded in the recording control area. Here, the “control information” of the present invention may be information which directly indicates a “relationship between the recording position and the laser power”, as in a “relationship between the recording position and an optimum laser power” described later, for example. Alternatively, it may be information which indirectly indicates the “relationship between the recording position and the laser power”, as in a “relationship between the recording position and recording sensitivity” described later, for example.

If an information recording apparatus described later reads the control information, it is possible to control the laser power of the laser light for recording the record information. For example, it is possible to optimize the laser power. Then, the control information is recorded in association with the recording position in the recording area. Therefore, in accordance with the recording position where the record information is to be recorded, it is possible to record the record information with a more preferable laser power. Moreover, if the control information corresponding to the recording position is included, even in the case in which the record information is recorded for the first time into the relevant recording position, it is possible to record the record information with a more preferable laser power, by referring to the control information.

Here, in the case in which the record information is recorded onto the information recording medium on which the control information is not recorded, the record information is recorded with the laser power, which is obtained before the recording operation by performing OPC described later, for example. However, in the information recording medium, since the recording sensitivity (or recording characteristics) varies depending on the recording position, due to a production condition thereof or the like, the laser power obtained by the OPC is not always optimum in an arbitrary recording position. However, according to the information recording medium in the embodiment, since the control information is recorded, there is such a great advantage that the record information can be recorded with a more preferable laser power according to the recording position.

Consequently, according to the information recording medium in the embodiment, it is possible to record the record information with a more preferable laser power according to the recording position, by using the control information. Therefore, at the time of the recording operation of the information recording apparatus described later, for example, it is possible to improve recording quality and reduce an error rate or the like upon reproduction of the recorded record information.

Incidentally, in the case of a multilayer type information recording medium having a plurality of recording layers, such as an information recording medium on which the above-mentioned recording area is formed in a laminated structure, it is preferable to have the control information for each recording area.

In one aspect of the embodiment of the information recording medium of the present invention, the control information indicates an association between information which represents the recording position in the recording area and information which represents recording sensitivity in the recording position.

According to this aspect, it is possible to record the record information with a preferable laser power, regardless of a difference in recording characteristics, caused by a difference in the production condition and the production process or the like of the information recording medium, for example. Here, the “information which represents recording sensitivity” indicates a correlation relationship between the recording position in the recording area and the recording sensitivity of the information recording medium, which may be recorded in a form of table, or may be recorded as a graph (or a function expression). Incidentally, the “recording sensitivity” in the present invention indicates recording characteristics in recording the record information into the recording area, and it is an index which indicates ease of recording or the like, for example. For example, if “the recording sensitivity is good (or high)”, the recording power necessary to record the record information may be relatively small. On the other hand, if “the recording sensitivity is bad (or low)”, the recording power necessary to record the record information may be relatively large.

In another aspect of the embodiment of the information recording medium of the present invention, the control information indicates an association between information which represents the recording position in the recording area and information which represents an optimum laser power in the recording position.

According to this aspect, it is possible to obtain the optimum recording laser power, relatively easily, by referring to the control information which directly indicates the optimum laser power according to the recording position, for example. Therefore, it is possible to further simplify the structure and the operation of the information recording apparatus described later. Such control information may also include the absolute value of the optimum laser power, for example, as the information which represents the optimum laser power.

Incidentally, the “optimum laser power” of the present invention is a wide concept not only indicating its literal meaning of the most suitable laser power, but also including a laser power to the extent that the record information can be more appropriately recorded upon the recording. More preferably, the optimum laser power is preferably a laser power to the extent that asymmetry does not influence the recording operation, as described in detail later, or to the extent that a situation in which the error rate is 0 or low enough to hardly influence the recording operation can be realized.

In another aspect of the embodiment of the information recording medium of the present invention, the control information indicates a correlation relationship between the recording position in the recording area and an optimum laser power in the recording position.

According to this aspect, it is possible to obtain the optimum laser power, relatively easily, by performing a predetermined operation or calculation or the like, for example, on the basis of the correlation relationship. Such control information may also include a graph (or a function), a list (or a table), or the like, which indicates the relationship between the optimum laser power and the recording position.

(Embodiments of Information Recording Apparatus)

A first embodiment of the information recording apparatus of the present invention is provided with: a recording device for recording record information by irradiating laser light onto the above-mentioned information recording medium (including its various aspects); and an optimizing device for optimizing a laser power, on the basis of the control information recorded in the recording control area of the information recording medium.

According to the first embodiment of the information recording apparatus of the present invention, as in the above-mentioned embodiment of the information recording medium of the present invention, it is possible to record the record information with a more preferable laser power according to the recording position, by using the control information.

Specifically, the recording device, including an optical pickup or the like, for example, records the various record information, which includes contents, such as video record information and music record information, or data information for a computer or the like, for example, by irradiating the information recording medium with the laser light. Then, the optimizing device, including a CPU or the like, for example, can optimize the laser power for recording the record information, by referring to the control information recorded in the recording control area. Incidentally, to “optimize” in the present invention is a concept indicating that a situation in which the record information can be recorded with a more preferable (or optimum) laser power can be realized, such as that the laser power is adjusted to be the optimum laser power, for example. Therefore, by referring to the control information, the recording device can record the record information with the optimum laser power, and the recording characteristics can be improved. As a result, there is also such an advantage that it is possible to reduce the error rate when the record information is reproduced, or the like. In addition, as describe above, the control information is information for controlling the laser power in accordance with the recording position in the information recording medium. Thus, the optimizing device can perform the optimization according to the recording position of the record information, and as a result, the recording device can record the record information with a more preferable (or optimum) laser power, in an arbitrary position or in almost whole positions of the information recording medium.

Consequently, according to the first embodiment of the information recording apparatus of the present invention, by referring to the control information, the recording device can record the record information with a more preferable laser power according to the recording position. In other words, it is possible to receive the various benefits owned by the information recording medium of the above-mentioned embodiment.

In one aspect of the first embodiment of the information recording apparatus of the present invention, the optimizing device roughly estimates the control information at a recording position for which the corresponding control information does not exist, on the basis of the control information recorded in the recording control area.

According to this aspect, for example, even in the recording position for which the corresponding control information does not exist (i.e. even if the control information for controlling the laser power in accordance with that recording position is not directly recorded), it is possible to generate the control information by a rough estimate, by referring to the existing control information. For example, if the control information indicates that the optimum laser power gradually increases from the inner circumferential side to the outer circumferential side in the information recording medium, such as a DVD, it is possible to estimate that the optimum laser power relatively increases, even if there is no control information corresponding to the outer circumferential side. Then, the specific value thereof may be roughly estimated on the basis of a rate (ratio) of increase in the optimum laser power indicated by the control information, or the like, for example. By this, if there is the control information corresponding to at least one portion of the recording position, for example, the recording device can record the record information with a more preferable laser power.

In another aspect of the first embodiment of the information recording apparatus of the present invention, the information recording apparatus is further provided with a storing device for storing therein the control information.

According to this aspect, it is possible to store the control information recorded on the information recording medium, into the storing device. Then, by using the stored control information, it is possible to optimize the laser power, as descried above. In particular, it is no longer necessary to sequentially read the control information from the information recording medium, such as a CD-ROM and a DVD-ROM, for example, having a relatively slow reading speed, and it is possible to read the control information from the storing device, such as a RAM, for example, having a relatively fast reading speed, and use it. Therefore, it is possible to perform a process which is performed by the optimizing device and which is necessary for the optimization, at higher speed. This has such a great advantage that it leads to the speeding up of the recording operation.

A second embodiment of the information recording apparatus of the present invention is provided with: a first recording device for irradiating laser light onto an information recording medium and for recording record information onto the information recording medium; a control information generating device for obtaining an optimum laser power according to a recording position of the information recording medium and for generating control information which indicates an association between information which represents the recording position and information which represents the optimum laser power; a second recording device for recording the control information generated by the control information generating device; and a controlling device for controlling a laser power of the laser light irradiated onto the information recording medium, on the basis of the control information recorded by the second recording device.

According to the second embodiment of the information recording apparatus of the present invention, it is possible to record the record information with a preferable recording power, by the operation of the first recording device.

Particularly, in the second embodiment of the information recording apparatus of the present invention, the control information generating device obtains the optimum recording laser power of the recording device during the recording operation, by performing running OPC or the like described later, for example. Then, moreover, the control information generating device generates the control information (e.g. a calibration curve described later) having a correlation relationship between the information which represents the optimum laser power and the information which represents the recording position. More specifically, the control information generating device generates a function expression, a table, or the like, which properly indicates the relationship between the recording position and the optimum laser power, on the basis of the recording position at which the optimum laser power is obtained and the optimum laser power. Specifically explaining this, in the case of the information recording medium, such as a DVD, if the optimum laser power is relatively small in a recording position on the relatively inner circumferential side and the optimum laser power is relatively large in a recording position on the relatively outer circumferential side, the control information generating device generates the control information which indicates the optimum laser power gradually decreases as the recording position is displaced or shifted from the inner circumferential side to the outer circumferential side. Then, the second recording device records the control information onto the information recording medium or into the storing device, such as a RAM, for example. Then, the controlling device, including a CPU or the like, for example, controls the laser power on the basis of the control information. For example, the controlling device may control the laser power so as to optimize it (i.e. to be the optimum laser power).

Therefore, the first recording device can record the record information with a laser power appropriately controlled (or optimized), to thereby improve the recording characteristics. As a result, there is such an advantage that it is possible to reduce the error rate when the record information is reproduced, or the like. In addition, the control information indicates a correspondence relationship between the recording position of the information recording medium and the optimum laser power. Thus, it is possible to more appropriately control the laser power in accordance with the recording position of the record information. As a result, the first recording device can record the record information with a preferable laser power, in an arbitrary position or in almost whole positions of the information recording medium. In particular, it is also possible to appropriately control the laser power even in a recording position at which the optimum laser power is not actually obtained, on the basis of the absolute value of the optimum laser power in a recording position at which the optimum laser power is actually obtained and an aspect of a change in the optimum laser power corresponding to a change in the recording position. For example, in the case of normal running OPC, the result of the running OPC is not particularly used except in order to obtain the optimum laser power in the recording position at which the running OPC is performed. However, according to the information recording apparatus of the second embodiment, it is possible to receive the various benefits, as described above, by accumulating the result (i.e. the optimum laser power) and using it in the subsequent control of the laser power. In this point, the information recording apparatus of the second embodiment is relatively excellent, as compared to the running OPC.

Consequently, according to the second embodiment of the information recording apparatus of the present invention, the first recording device can record the record information with a more preferable laser power (or optimum laser power) according to the recording position, by using the control information generated by the control information generating device during the recording operation.

In another aspect of the second embodiment of the information recording apparatus of the present invention, the second recording device records the control information generated by the control information generating device, onto the information recording medium.

According to this aspect, there is such a great advantage that it is possible to control the laser power, not only on the information recording apparatus which actually generates the control information, but also on another information recording apparatus (e.g. an information recording apparatus which has not recorded the record information onto the information recording medium, or the like), by referring to the control information or the like recorded on the information recording medium.

In addition, it is possible to generate the newest control information in which the content of the previously generated control information is reflected. Therefore, it is possible to generate the control information which is a basis for controlling the laser power, more preferably. In other words, this aspect has a great advantage in the point that it is possible to use the control information in which the optimum laser power obtained by the control information generating device is cumulatively reflected.

Incidentally, if the information recording apparatus has the storing device, such as a RAM, it may be constructed such that the control information is recorded into the storing device.

In another aspect of the second embodiment of the information recording apparatus of the present invention, the control information generating device generates the control information, on the basis of a calibration value of a laser power obtained by performing running OPC

(Optimum Recording Calibration).

According to this aspect, it is possible to generate the control information with higher reliability, on the basis of the calibration value (e.g. ROPC data described later). A specific explanation about the generation of the control information based on the result of the running OPC will be described in detail in Examples later.

In another aspect of the second embodiment of the information recording apparatus of the present invention, the control information generating device generates the control information corresponding to each predetermined area of the information recording medium.

According to this aspect, it is possible to generate the control information corresponding to each predetermined area, such as a radial position, of the information recording medium, for example. Therefore, even if the recording position is changed throughout the entire information recording medium, it is possible to control the laser power in accordance with the change, by referring to the control information. At this time, the predetermined area may be averagely assigned throughout the entire information recording medium, or may be a randomly assigned area.

In another aspect of the second embodiment of the information recording apparatus of the present invention, the control information generating device generates the control information corresponding to a recording linear velocity of the information recording medium.

According to this aspect, for example, in the case of a Z-CLV (Zone Constant Linear Velocity), it is possible to generate the control information corresponding to a difference in the recording linear velocity. Therefore, it is possible to control the laser power in accordance with a difference in the recording linear velocity.

In another aspect of the second embodiment of the information recording apparatus of the present invention, the information recording medium is provided with a plurality of recording layers, and the controlling device controls the laser power irradiated to another recording layer, on the basis of the control information obtained in one recording layer, in a case in which a target, to which the recording device performs recording operation, is changed from the one recording layer to the another recording layer out of the plurality of recording layers.

According to this aspect, even in the case of another recording layer into which the record information has not been recorded yet, for example, it is possible to control the laser power in the another recording layer, on the basis of the control information in the one recording layer in which it is estimated that it has substantially the same recording characteristics as those of the another recording layer. Therefore, even if the record information is recorded onto the information recording medium having the plurality of recording layers, it is possible to record the record information with a more preferable laser power in an arbitrary recording layer.

In another aspect of the second embodiment of the information recording apparatus of the present invention, the information recording medium is provided with a plurality of recording layers, and the control information generating device generates the control information in another recording layer, on the basis of the control information obtained in one recording layer, in a case in which a target, to which the recording device performs recording operation, is changed from the one recording layer to the another recording layer out of the plurality of recording layers.

According to this aspect, even in the case of another recording layer where the record information has not been recorded yet, for example, it is possible to generate the control information in the another recording layer, on the basis of the control information in the one recording layer in which it is estimated that it has substantially the same recording characteristics as those of the another recording layer.

(Embodiments of Information Recording Method)

A first embodiment of the information recording method of the present invention is provided with: a recording process of recording record information by irradiating laser light onto the above-mentioned embodiment of the information recording medium the present invention (including its various aspects); and an optimizing process of optimizing a laser power, on the basis of the control information recorded in the recording control area of the information recording medium.

According to the first embodiment of the information recording method of the present invention, as in the first embodiment of the information recording apparatus of the present invention, it is possible to optimize the laser power in the optimizing process, and record the record information with the optimized laser power, in the recording process. Therefore, it is possible to receive the same various benefits as those in the first embodiment of the information recording apparatus of the present invention.

Incidentally, in response to the various aspects of the above-mentioned first embodiment of the information recording apparatus of the present invention, the first embodiment of the information recording method of the present invention can also adopt various aspects.

A second embodiment of the information recording method of the present invention is provided with: a first recording process of irradiating laser light onto an information recording medium and of recording record information onto the information recording medium; a control information generating process of obtaining an optimum laser power according to a recording position of the information recording medium and of generating control information which indicates an association between the recording position and information which represents the optimum laser power; a second recording process of recording the control information generated in the control information generating process; and a controlling process of controlling a laser power of the laser light irradiated onto the information recording medium, on the basis of the control information recorded in the second recording process.

According to the second embodiment of the information recording method of the present invention, as in the second embodiment of the information recording apparatus of the present invention, it is possible to record the record information in the first recording process, obtain the optimum laser power and generate the control information in the control information generating process, record the control information in the second recording process, and control the laser power on the basis of the control information in the controlling process. Therefore, it is possible to receive the same various benefits as those in the second embodiment of the information recording apparatus of the present invention.

Incidentally, in response to the various aspects of the above-mentioned second embodiment of the information recording apparatus of the present invention, the second embodiment of the information recording method of the present invention can also adopt various aspects.

(Embodiment of Information Recording/Reproducing Apparatus)

An embodiment of the information recording/reproducing apparatus of the present invention is provided with: the above-mentioned first or second information recording apparatus of the present invention (including its various aspects); and a reproducing device for reproducing the record information recorded on the information recording medium.

According to the embodiment of the information recording/reproducing apparatus of the present invention, it is possible to receive the various benefits owned by the above-mentioned first or second embodiment of the information recording apparatus of the present invention. It is also possible to reproduce the record information by using the reproducing device which is provided with an optical pickup, a RF detector, a push-pull detector, or the like.

Incidentally, in response to the various aspects of the above-mentioned first or second embodiment of the information recording apparatus of the present invention, the embodiment of the information recording/reproducing apparatus of the present invention can also adopt various aspects.

(Embodiment of Information Recording/Reproducing Method)

An embodiment of the information recording/reproducing method of the present invention is provided with: the above-mentioned first or second information recording method of the present invention (specifically, its each process); and a reproducing process of reproducing the record information recorded on the information recording medium.

According to the embodiment of the information recording/reproducing method of the present invention, it is possible to receive the various benefits owned by the above-mentioned first or second embodiment of the information recording method of the present invention. It is also possible to reproduce the record information, in the reproducing process performed by the operation of an optical pickup, a RF detector, a push-pull detector, or the like.

Incidentally, in response to the various aspects of the above-mentioned first or second embodiment of the information recording method of the present invention, the embodiment of the information recording/reproducing method of the present invention can also adopt various aspects.

(Embodiments of Computer Program)

A first embodiment of the computer program of the present invention makes a computer function as the above-mentioned first information recording apparatus (including its various aspects). More specifically, it makes the computer function as at least one portion of the recording device and the optimizing device in the above-mentioned first embodiment of the information recording apparatus.

According to the first embodiment of the computer program of the present invention, the above-mentioned first embodiment of the information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned first embodiment of the information recording apparatus of the present invention, the first embodiment of the computer program of the present invention can also adopt various aspects.

A second embodiment of the computer program of the present invention makes a computer function as the above-mentioned second information recording apparatus (including its various aspects). More specifically, it makes the computer function as at least one portion of the first recording device, the control information generating device, the second recording device, and the controlling device in the above-mentioned second embodiment of the information recording apparatus.

According to the second embodiment of the computer program of the present invention, the above-mentioned second embodiment of the information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned second embodiment of the information recording apparatus of the present invention, the second embodiment of the computer program of the present invention can also adopt various aspects.

A third embodiment of the computer program of the present invention makes a computer function as the above-mentioned information recording/reproducing apparatus (including its various aspects). More specifically, it makes the computer as at least one portion of the above-mentioned first or second information recording apparatus and the reproducing device.

According to the third embodiment of the computer program of the present invention, the above-mentioned embodiment of the information recording/reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned embodiment of the information recording/reproducing apparatus of the present invention, the third embodiment of the computer program of the present invention can also adopt various aspects.

The above object of the present invention can be also achieved by a first embodiment of a computer program product in a computer-readable medium for tangibly embodying a program of instructions executable by a computer, to make the computer function as the above-mentioned first embodiment of the information recording apparatus (including its various aspects). More specifically, it makes the computer function as at least one portion of the recording device and the optimizing device in the above-mentioned first embodiment of the information recording apparatus.

The above object of the present invention can be also achieved by a second embodiment of a computer program product in a computer-readable medium for tangibly embodying a program of instructions executable by a computer, to make the computer function as the above-mentioned second embodiment of the information recording apparatus (including its various aspects). More specifically, it makes the computer function as at least one portion of the first recording device, the control information generating device, the second recording device, and the controlling device in the above-mentioned second embodiment of the information recording apparatus.

The above object of the present invention can be also achieved by a third embodiment of a computer program product in a computer-readable medium for tangibly embodying a program of instructions executable by a computer, to make the computer function as the above-mentioned information recording/reproducing apparatus (including its various aspects). More specifically, it makes the computer function as at least one portion of the above-mentioned first or second embodiment of the information recording apparatus and the reproducing device.

According to the first, second, or third embodiment of the computer program product of the present invention, at least one portion of the above-mentioned first or second embodiment of the information recording apparatus or the information recording/reproducing apparatus of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the above-mentioned first or second embodiment of the information recording apparatus or the information recording/reproducing apparatus of the present invention.

These effects and other advantages of the present invention become more apparent from the following examples.

As explained above, according to the embodiment of the information recording medium of the present invention, it is provided with: the recording area; and the recording control area. Therefore, it is possible to record the record information with a more preferable laser power according to the recording position, by using the control information.

Moreover, the first embodiment of the information recording apparatus or method of the present invention is provided with: the recording device; and the optimizing device, or the recording process; and the optimizing process. Therefore, it is possible to record the record information with a laser power optimized (i.e. more preferable) in accordance with the recording position, by using the control information.

Moreover, the second embodiment of the information recording apparatus or method of the present invention is provided with: the first recording device; the control information generating device; the second recording device; and the controlling device, or the first recording process; the control information generating process; the second recording process; and the controlling process. Therefore, it is possible to record the record information with a laser power optimized (i.e. more preferable) in accordance with the recording position, by using the control information obtained by the control information generating device during the recording operation.

Moreover, according to the embodiment of the information recording/reproducing apparatus, it is provided with: the information recording apparatus in the first or second embodiment; and the reproducing apparatus. Therefore, it is possible to receive the various benefits owned by the information recording apparatus in the first or second embodiment. At the same time, it is possible to reproduce the record information.

### EXAMPLES

Hereinafter, examples of the present invention will be discussed with reference to the drawings.

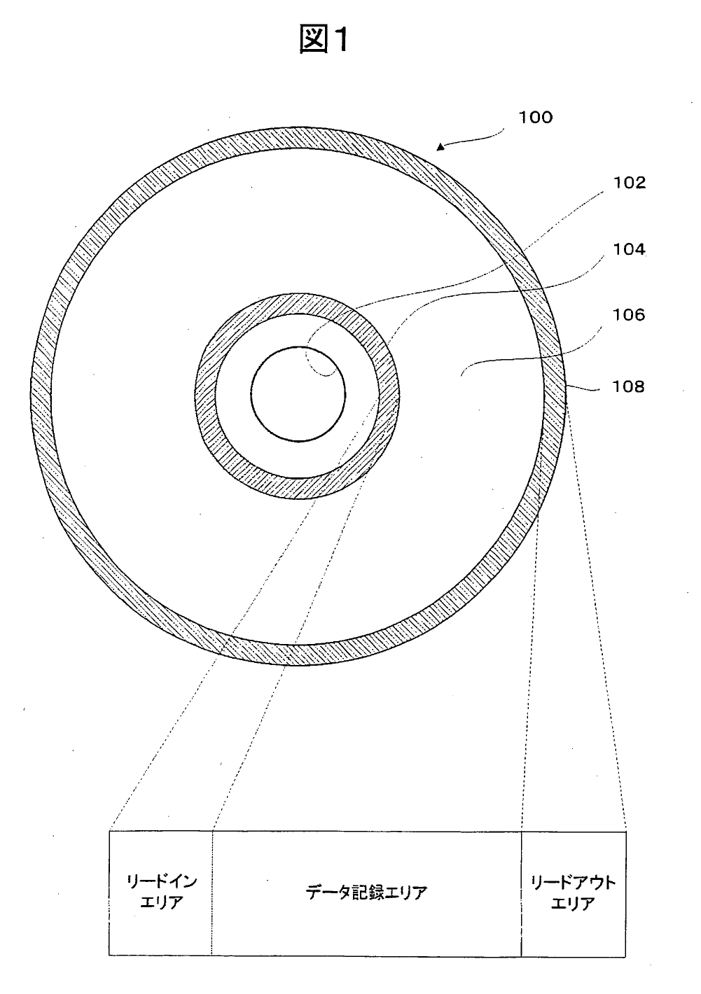

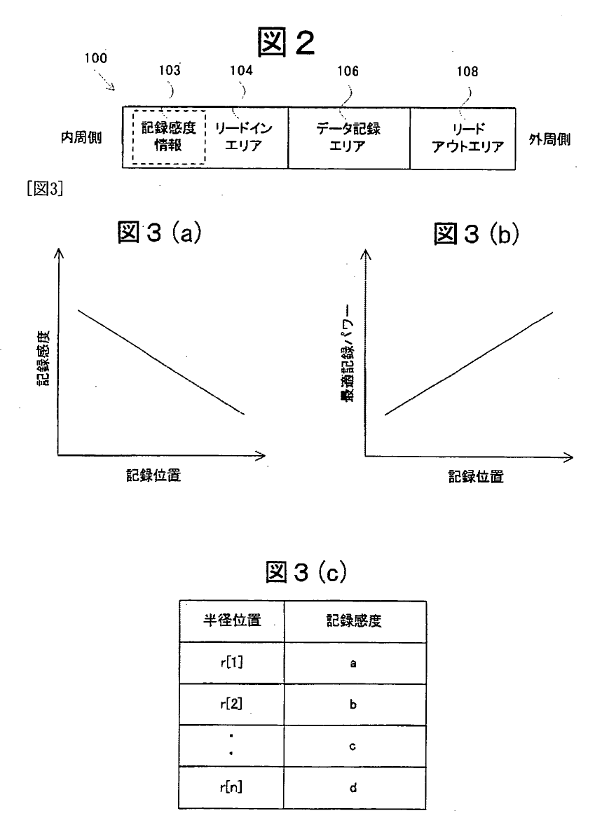

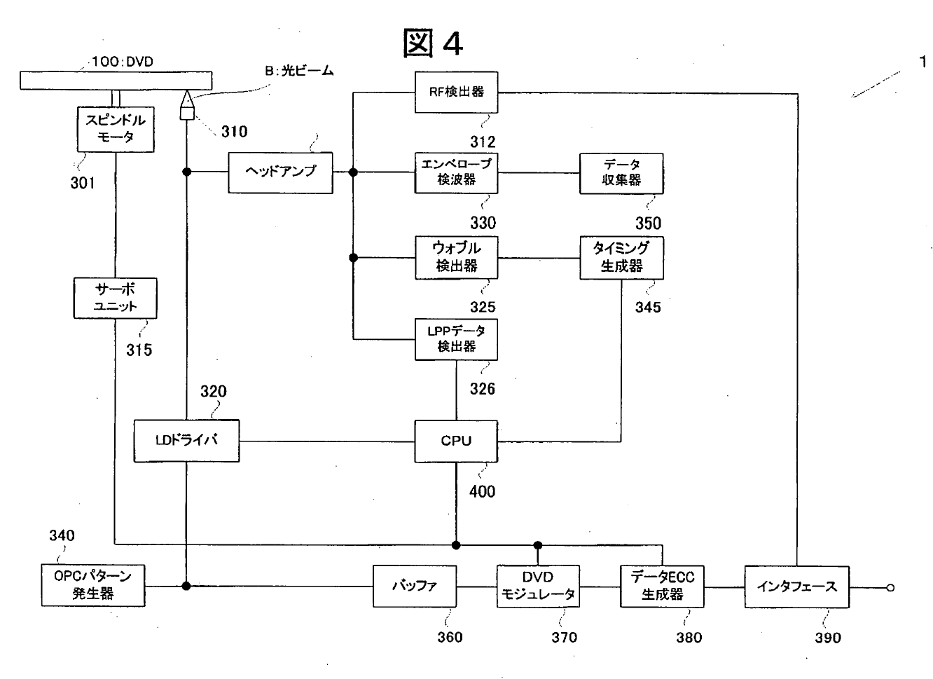

At first, with reference to FIG. 1 to FIG. 3, an information recording medium used in examples of the information recording apparatus of the present invention will be discussed. In this example, an optical disc is used for explanation, as the information recording medium. FIG. 1 shows the structure of the optical disc having a plurality of areas in a substantial plan view on the upper part, and correspondingly shows an area structure in the radial direction in a conceptual view on the lower side. FIG. 2 is a data structural view conceptually showing the data structure of the optical disc in the example. FIG. 3 are graphs and a list conceptually showing recording-sensitivity information, recorded on the optical disc in the example.

As shown in FIG. 1, on an optical disc 100, recording (writing) can be performed a plurality of times or once, in various recording methods, such as a magneto optical method and a phase change method. The optical disc 100 has a recording surface on a disc main body with a diameter of about 12 cm, as is a DVD. On the recording surface, the optical disc 100 is provided with: a lead-in area 104; a data recording area 106 as being one specific example of the “recording area” of the present invention; and a lead-out area 108, from the inner circumference to the outer circumference, with a center hole 102 as the center. Then, in each recording area, groove tracks and land tracks are alternately provided, spirally or concentrically, with the center hole 102 as the center. The groove tracks may be wobbled, or pre-pits may be formed on one of or both of the tracks. Incidentally, the present invention is not particularly limited to the optical disc having these three areas. For example, even if the lead-in area 104 or the lead-out area 108 does not exist, a file structure explained below can be constructed. Moreover, as described later, the lead-in area 104 and the lead-out area 108 may be further segmentized.

The data structure of the optical disc 100 will be explained in more detail, with reference to FIG. 2. As shown in FIG. 2, on the optical disc 100, recording-sensitivity information 103 as being one specific example of the “control information” of the present invention is recorded in the lead-in area 104. The recording-sensitivity information 103 indicates an aspect or the like of a change in recording-sensitivity according to a position on the optical disc 100. For example, the recording-sensitivity information 103 indicates an aspect of the change in recording-sensitivity according to a radial position or the like centered on the center hole 102 of the optical disc 100. Such a change in the recording-sensitivity appears due to a difference in the production condition of the optical disc (e.g. a production process, an environment upon production, etc.) and a material used for the recording layers (e.g. organic dye, an amorphous material, etc.), or the like.

The recording-sensitivity information 103 is preferably recorded in advance by a manufacturer or the like, upon the production of the optical disc 100. Moreover, in the example, the recording-sensitivity information 103 is recorded by land pre-pit (LPP). However, it may be recorded by other aspects (e.g. a particular pit, etc.).

Then, as shown in FIG. 3(a), the recording-sensitivity information 103 may be recorded as a graph (or a function expression) which indicates a correlation relationship between the recording position (e.g. the radial position centered on the center hole 102 of the optical disc 100) of the data on the optical disc 100 and the recording-sensitivity. The recording-sensitivity information 103 (i.e. the graph) shown in FIG. 3(a) shows that as the radial position is shifted to the outer circumferential side, the recording sensitivity gradually decreases.

Alternatively, as shown in FIG. 3(b), the recording-sensitivity information 103 may be recorded as a graph (or a function) which indicates a correlation relationship between the recording position (e.g. the radial position centered on the center hole 102 of the optical disc 100) of the data on the optical disc 100 and the optimum recording laser power. The recording-sensitivity information 103 (i.e. the graph) shown in FIG. 3(b) shows that as the radial position is shifted to the outer circumferential side, an optimum recording laser power gradually increases. Incidentally, considering the fact that the recording laser power necessary for an appropriate recording operation is reduced in response to an improvement in the recording-sensitivity, the recording-sensitivity information 103 shown in FIG. 3(b) indicates that as the radial position is shifted to the outer circumferential side, the optimum recording laser power gradually decreases, as in the recording-sensitivity information 103 shown in FIG. 3(a).

Incidentally, the optimum recording laser power in this case may be expressed by an absolute value thereof, or may be expressed by a ratio based on the value of the optimum recording laser power in a predetermined radial position. The predetermined radial position may be a radial position on the most inner circumferential side, a predetermined radial position on the data recording area, a radial position on the most outer circumferential side or the other radial positions. Then, particularly in the case in which the recording-sensitivity information 103 expresses the ratio of the optimum recording laser power, the power value which is to be a reference is preferably an optimum recording laser power in an area where an information recording apparatus, described later, performs the OPC (i.e. a recording laser power obtained by the OPC). Namely, it is preferably based on the recording laser power in an OPC area as being an area to perform the OPC which exists in the lead-in area 104.

Alternatively, as shown in FIG. 3(c), the recording-sensitivity information 103 may be recorded as a correspondence list between discrete or dispersed radial positions centered on the center hole 102 of the optical disc 100 and the recording-sensitivity. Incidentally, the radial positions are not limited to the discrete radial positions extracted in arbitrary interval units, but may be continuous radial positions, for example.

Moreover, as the recording-sensitivity information 103, it may be constructed to include a calibration curve and ROPC data or the like, as described later, or to include information which directly indicates the value of the optimum recording laser power.

As described above, since the optical disc 100 is provided with the recording-sensitivity information 103 in advance, the information recording apparatus described later can record the data with a more preferable recording laser power (e.g. the optimum recording laser power), by referring to the recording-sensitivity information 103. For example, it is assumed that a recording position thereof is sequentially shifted to the outer circumferential side, while the data is recorded with the optimum recording laser power which is calculated by OPC, described later, before the start of the recording operation. On the other hand, according to the recording-sensitivity information 103, it is assumed that as the recording position is shifted to the outer circumferential side, the recording-sensitivity is also reduced. In this case, the information recording apparatus described later can recognize that the recording-sensitivity is also reduced by referring to the recording-sensitivity information 103 as the recording position is shifted to the outer circumferential side. For this, the information recording apparatus can sequentially increase the recording laser power as the recording position is shifted to the outer circumferential side. In other words, it is possible to record the data with a more preferable recording laser power according to the recording-sensitivity of the optical disc 100.

If the recording-sensitivity information 103 does not exist, the information recording apparatus described later records the data with the optimum recording laser power calculated by the OPC before the start of the recording operation, in an arbitrary recording position of the optical disc 100. However, since the optical disc 100 has such a characteristic that the recording-sensitivity varies depending on the recording position, the optimum recording laser power calculated by the OPC is not always optimum in an arbitrary recording position. In particular, since the OPC is performed by recording test-write data in the OPC area disposed in the lead-in area 104, it can be considered that the optimum recording laser power also changes as the recording position is shifted to the outer circumferential side. In other words, it is not always possible to record the data with the appropriate recording laser power, and there is such a disadvantage that this may lead to an increase in an error rate upon reproduction.

However, according to the optical disc 100 in the example, since it is provided with the recording-sensitivity information 103 in advance, it is possible to record the data with a preferable recording laser power, regardless of the change in the recording-sensitivity, caused by a change in the recording position. Then, even if the data is recorded into an arbitrary position of the optical disc 100, it is possible to obtain the optimum recording laser power on the basis of the recording-sensitivity information. Thus, it is possible to effectively prevent the above-mentioned disadvantage, and it is possible to enable the information recording apparatus described later to record the data, more appropriately, even in an arbitrary recording position. Namely, it is possible to improve the recording quality of the data, and as a result, it is possible to receive various benefits, such as a reduction in the error rate upon data reproduction.

### First Example of Information Recording Apparatus

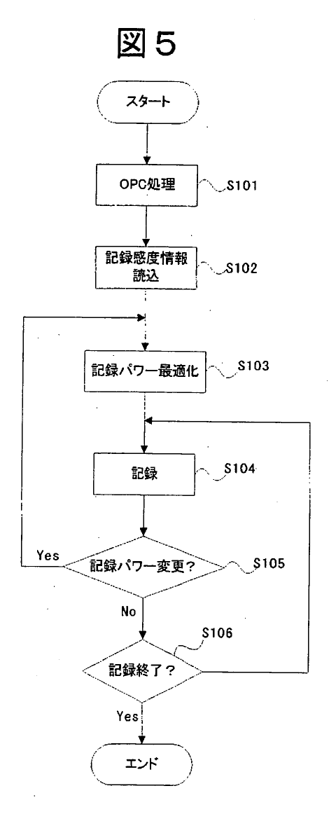

Next, with reference to FIG. 4 to FIG. 6, the first example of the information recording apparatus of the present invention will be discussed.

(1) Basic Structure

At first, with reference to FIG. 4, the basic structure of the information recording apparatus in the first example will be discussed. FIG. 4 is a block diagram conceptually showing the basic structure of the information recording apparatus in the first example.

As shown in FIG. 4, an information recording apparatus 1 in the example is provided with: a spindle motor 301; an optical pickup 310; a head amplifier 311; a RF detector 312; a servo circuit 315; an LD driver 320; a wobble detector 325; a LPP data detector 326; an envelope detector 330; an OPC pattern generator 340; a timing generator 345; a data collector 350; a buffer 360; a DVD modulator 370; a data ECC generator 380; a buffer 385; an interface 390; and a CPU 400.

The spindle motor 301 is constructed to rotate the optical disc 100 at a predetermined speed under spindle servo from the servo circuit 315 or the like.

The optical pickup 310 is intended to perform the recording/reproduction with respect to the optical disc 100, and is provided with a semiconductor laser device, various lenses, an actuator and the like. More specifically, the optical pickup 310 irradiates the optical disc 100 with a light beam, such as laser light, as reading light with a first power upon reproduction, and as writing light with a second power upon recording, with it modulated. The optical pickup 310 is constructed to be displaced in the radial direction or the like of the optical disc 100, by a not-illustrated actuator, slider, or the like, which is driven by the servo circuit 315.

The head amplifier 311 amplifies the output signal (i.e. the reflected light of a light beam B) of the optical pickup 310, and outputs the amplified signal. Specifically, a RF signal as being a reading signal is outputted to the RF detector 312 and the envelope detector 330, and a push-pull signal is outputted to the wobble detector 325.

The RF detector 312 is constructed to detect the RF signal and perform demodulation or the like, to thereby output it to the exterior through the interface 390. Namely, it is possible to make the information recording apparatus function as an information reproducing apparatus or information recording/reproducing apparatus.

The servo circuit 315 displaces the objective lens of the optical pickup 310, on the basis of a tracking error signal and a focus error signal or the like, which are obtained by processing the light receiving result of the optical pickup 310, to thereby perform various servo processes, such as tracking control and focus control. Moreover, the servo circuit 315 is constructed to servo-control the spindle motor 301, on the basis of a wobble signal obtained from the wobble of the wobbled groove tracks on the optical disc 100.

The LD driver 320 drives the semiconductor laser disposed in the optical pickup 310, in order to determine an optimum recording laser power in the recording and reproduction processes of an OPC pattern described later, at the time of the OPC process. After that, the LD driver 320 drives the semiconductor laser of the optical pickup 310 with the optimum recording laser power determined by the above-mentioned OPC process, upon the data recording. Upon the data recording, the optimum recording laser power is modulated in accordance with the record data.

Incidentally, one specific example of the “recording device” of the present invention is constructed by including the spindle motor 301, the optical pickup 310, the servo circuit 315, the LD driver 320, described above, or the like.

The wobble detector 325 is constructed to detect a push-pull signal which indicates the wobble signal, on the basis of the output signal corresponding to the light requirement from the head amplifier 311, which is a detector, disposed in the optical pickup 310, for receiving a reflected light beam, and to output it to the timing generator 345.

The LPP data detector 326 is constructed to detect a push-pull signal which indicates an LPP signal, on the basis of the output signal corresponding to the light amount from the head amplifier 311, which is a detector and disposed in the optical pickup 310, for receiving a reflected light beam, and to detect the recording-sensitivity information 103 included in the LPP signal. Then, the LPP data detector 326 is constructed to output the detected recording-sensitivity information 103 to the CPU 400.

Moreover, the LPP data detector 326 is constructed to detect pre-format address information indicated by an LPP signal. Then, the LPP data detector 326 is constructed to output the pre-format address information to the timing generator 345.

The envelope detector 330 is constructed to detect the peak value and the bottom value of envelope detection of the RF signal as being the output signal from the head amplifier 311, in order to determine the optimum recording laser power, under the control of the CPU 400, upon the reproduction of the OPC pattern in the OPC process. The envelope detector 330 may include an A/D (Analog/Digital) converter or the like, for example.

The OPC pattern generator 340 is constructed to output a signal which indicates the OPC pattern to the LD driver 320, on the basis of a timing signal from the timing generator 345, upon the recording of the OPC patter in the OPC process.

The timing generator 345 detects absolute position information based on the management unit of the pre-format address information (e.g. an ADIP word), on the basis of the pre-format address information inputted by the LPP data detector 326, upon the recording of the OPC pattern in the OPC process. Simultaneously, the timing generator 345 detects relative position information based on a slot unit (e.g. a slot unit corresponding to a length which is a natural number multiple of one cycle of the wobble signal) which is smaller than the management unit of the pre-format address information, on the basis of the cycle of the push-pull signal which indicates the wobble signal. Thus, whether or not a recording start position in the OPC process starts from the boundary of the management unit of the pre-format address information, i.e. each ADIP word, the timing generator 345 can specify the recording start position. After that, the timing generator 345 generates and outputs a timing signal for writing the OPC pattern, on the basis of the cycle of the push-pull signal which indicates the wobble signal outputted from the wobble detector 345. On the other hand, the timing generator 345 can specify a reproduction start position, upon the reproduction of the OPC pattern in the OPC process, as in the recording. After that, the timing generator 345 generates and outputs a timing signal for sampling the reproduced OPC pattern, on the basis of the cycle of the push-pull signal which indicates the wobble signal outputted from the wobble detector 345.

The data collector 350 is mainly a memory in general. For example, it is provided with an external RAM or the like. An envelope detected by the envelope detector 330 is stored into the data collector 350, and on the basis of this, the detection of an optimum recording laser power on the CPU 400, i.e., the OPC process, is performed.

The buffer 360 is constructed to store therein the record data modulated by the DVD modulator 370 and output it to the LD driver 320.

The DVD modulator 370 is constructed to perform DVD modulation with respect to the record data, and output it to the buffer 360. As the DVD modulation, for example, EFM (Eight to Fourteen Modulation) may be performed.

The data ECC generator 380 appends or adds a code for error correction to the record data which is inputted from the interface 390. Specifically, the data ECC generator 380 appends an ECC code in each predetermined block unit (e.g. ECC cluster unit), and outputs it to the DVD modulator 370.

The interface 390 receives the input of the record data or the like from external input equipment, and outputs it to the data ECC generator 380. Moreover, it may be constructed to output the reproduction data outputted from the RF detector 312, to the external output equipment, such as a speaker and a display.

The CPU 400 controls the information recording apparatus 1 as a whole, by giving an instruction, i.e. by outputting a system command, to each device, such as the LD driver 320 and the servo circuit 315, in order to detect the optimum recording laser power. Normally, software for operating the CPU 400 is stored in an internal or external memory.

(2) Operation Principle

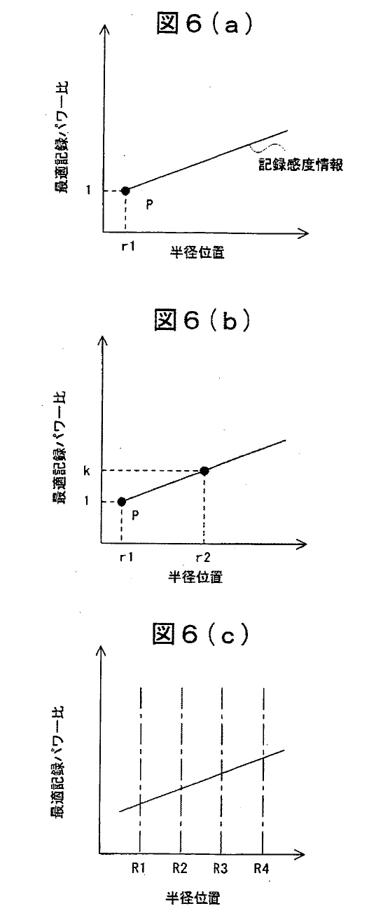

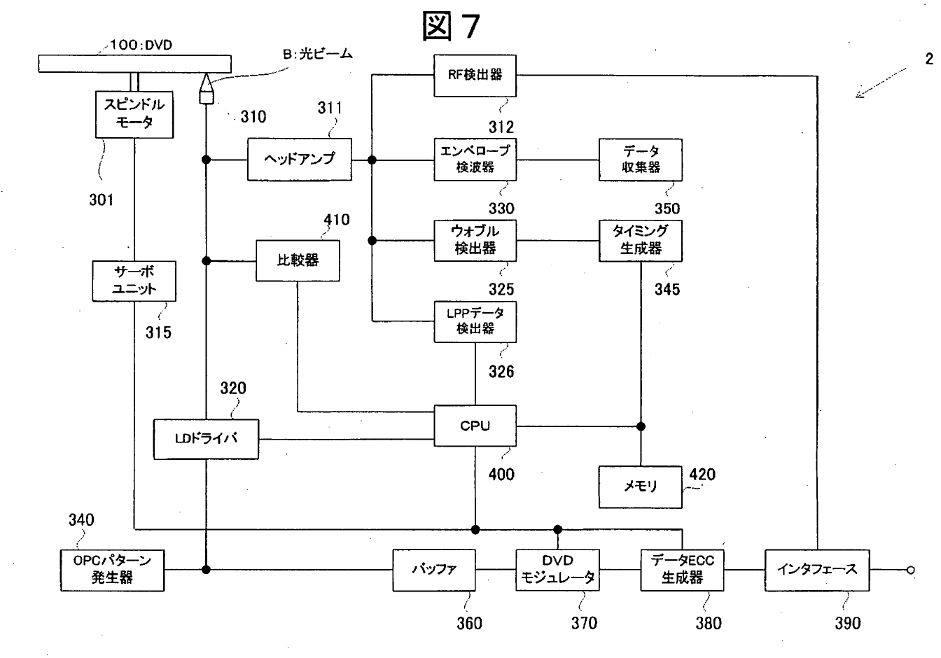

Next, with reference to FIG. 5 and FIG. 6, the recording operation of the information recording apparatus 1 in the first example will be explained. FIG. 5 is a flowchart showing a flow of the entire recording operation of the information recording apparatus in the first example. FIG. 6 are graphs conceptually showing a state of optimization of a recording laser power.

As shown in FIG. 5, at first, the information recording apparatus 1 performs the OPC process (step S101). Now, the OPC process is explained, more specifically. At first, under the control of the CPU 400, the optical pickup 310 is displaced to the OPC area disposed in the lead-in area 104. Then, by the control of the OPC pattern generator 340 and the LD driver 320 or the like, the recording laser power (e.g. mutually different 16 step recording laser power) is changed sequentially in stages, and the OPC pattern is recorded into the OPC area. As the OPC pattern, a recording pattern in which a short pit corresponding to a 3T pulse and a long pit corresponding to 11T pulse are alternately formed with respective non-recording sections, which have the same length as that of the short pulse or the long pulse, is taken as one example.

The LD driver 320 drives the semiconductor laser in the optical pickup 310, in order to change the recording laser power sequentially in stages, in accordance with the OPC pattern outputted from the OPC pattern generator 340.

Moreover, after the completion of the test-writing into the OPC area, the OPC pattern test-written in the OPC area is reproduced, under the control of the CPU 400. Then, from the RF signal inputted to the envelope detector 330, the peak value and the bottom value of the envelope detection of the RF signal are sampled and outputted to the data collector 350. Then, under the control of the CPU 400, the peak value and the bottom value are stored into the data collector 350. Then, after the OPC pattern is reproduced, in accordance with the number of times that the OPC pattern is recorded, in one OPC process, the optimum recording laser power is determined. Namely, the optimum recording laser power which approximately minimizes a jitter value which represents the quality of a recording characteristic, is calculated from the asymmetry obtained from the peak value and the bottom value.

Then, the recording-sensitivity information 103 is read (step S102). Here, the LPP data detector 326 detects the recording-sensitivity information 103 from the land pre-pit (LPP) formed on the optical disc 100. Then, the detected recording-sensitivity information 103 is outputted to the CPU 400 and used for the subsequent optimization of the recording laser power.

After that, the recording laser power is optimized (step S103). More specifically, the CPU 400 as being one specific example of the “optimizing device” of the present invention compares recording-sensitivity in a recording position where the data will be recorded from now with recording-sensitivity in a recording position where the OPC has been performed. If the recording-sensitivity in the recording position where the data will be recorded from now is greater than the recording-sensitivity in the recording position where the OPC has been performed, the optimum recording laser power calculated by the OPC is reduced. On the other hand, if the recording-sensitivity in the recording position where the data will be recorded from now is less than the recording-sensitivity in the recording position where the OPC has been performed, the optimum recording laser power calculated by the OPC is increased.

Specifically, for example, as shown in FIG. 6(a), it is assumed that the ratio of the optimum recording laser power in a predetermined recording position is determined from the recording-sensitivity information 103. At this time, it is assumed that the ratio of the optimum recording laser power is based on a power value in a recording position corresponding to the OPC area (i.e. a recording position related to a radial position of r1). Then, it is assumed that the optimum recording laser power in the radial position r1 is obtained as a value P, by the OPC process).

Then, in the case where the data is recorded into a recording position related to a radial position r2, as shown in FIG. 6(b), if the ratio of the optimum recording laser power in this radial position is represented by k, the value of the optimum recording laser power in the radial position r2 can be obtained by P×k.

Moreover, if the recording-sensitivity information 103 only has information corresponding to some recording position of the optical disc 100 (e.g. the recording-sensitivity and the ratio of the recording laser power), it may be constructed such that the recording laser power in a recording position where the recording-sensitivity information 103 does not exist is estimated from the recording-sensitivity information 103 that currently exists. For example, in the case of the graph of the recording-sensitivity information 103 as shown in FIG. 6(a), it is possible to approximately estimate the ratio of the recording laser power by extending the graph.

In FIG. 5 again, the data is recorded with the recording laser power optimized in the step S103 (step S104).

After that, it is judged by the CPU 400 as occasion demands, for example, whether or not to change the recording laser power (step S105). The CPU 400 may judge that the recording laser power is to be changed if the position to record the data greatly changes. Alternatively, in the case in which the data is recorded on the optical disc having a plurality of recording layers, the CPU 400 may judge that the recording laser power is to be changed in recording the data into the different layer. For example, as shown in FIG. 6(c), if the radial position exceeds each of R1, R2, R3, and R4, the CPU 400 may judge that the recording laser power is to be changed.

In FIG. 5 again, as a result of the judgment, if it is judged that the recording laser power is to be changed (the step S105: Yes), the operational flow returns to the step S103 again, to optimize the recording laser power. Specifically, for example, if the recording position is changed, the recording laser power is optimized to be an appropriate recording laser power as shown in FIG. 6(a) and FIG. 6(b), on the basis of the recording-sensitivity information and the recording position after the change.

On the other hand, if it is judged that the recording laser power is not to be changed (the step S105: No), then, it is judged whether or not to end the recording operation, under the control of the CPU 400 (step S106). Here, if the data to be recorded is all recorded in the recording operation, it may be judged that the recording operation is ended.

As a result of the judgment, if it is judged that the recording operation is ended (the step S106: Yes), the recording operation is ended. On the other hand, if it is judged the recording operation is not ended (the step S106: No), the operational flow returns to the step S104, to continue the recording operation.

Consequently, according to the information recording apparatus 1 in the first example, it is possible to obtain the optimum recording laser power, relatively easily, by using the recording-sensitivity 103 recorded in advance on the optical disc 100. As a result, it is possible to record the data with a preferable recording laser power, regardless of the change in the recording-sensitivity, caused by the change in the recording position. In other words, it is possible to receive the various benefits owned by the information recording medium in the above-mentioned example (i.e. the optical disc 100). Then, even in the optimum recording laser power in the recording position where the recording-sensitivity 103 does not exist, it is possible to predict an almost accurate value by estimating it from the recording-sensitivity 103.

Incidentally, the information recording apparatus 1 in the first example may be provided with a memory for recording therein the recording-sensitivity 103 read from the optical disc 100. The memory is preferably a semiconductor memory, such as a RAM and a flush memory, fore example. By this, the recording-sensitivity 103 can be read, not from the optical disc 100 having a relatively slow reading speed, but from the memory having a relatively fast reading speed. In addition, in order to read the recording-sensitivity 103, it is no longer necessary to sequentially read it from the optical disc 100. Therefore, there is such a great advantage that it is possible to realize the speeding up of the recording operation.

Incidentally, the information recording apparatus in the first example, explained with reference to FIG. 4, is also used as an example of the information recording/reproducing apparatus. Namely, it can reproduce the record information through the head amplifier 311 and the RF detector 312, and this example includes the function of the information reproducing apparatus or the function of the information recording/reproducing apparatus. The same is true for an information recording apparatus in a second example, described later.

### Second Example of Information Recording Apparatus

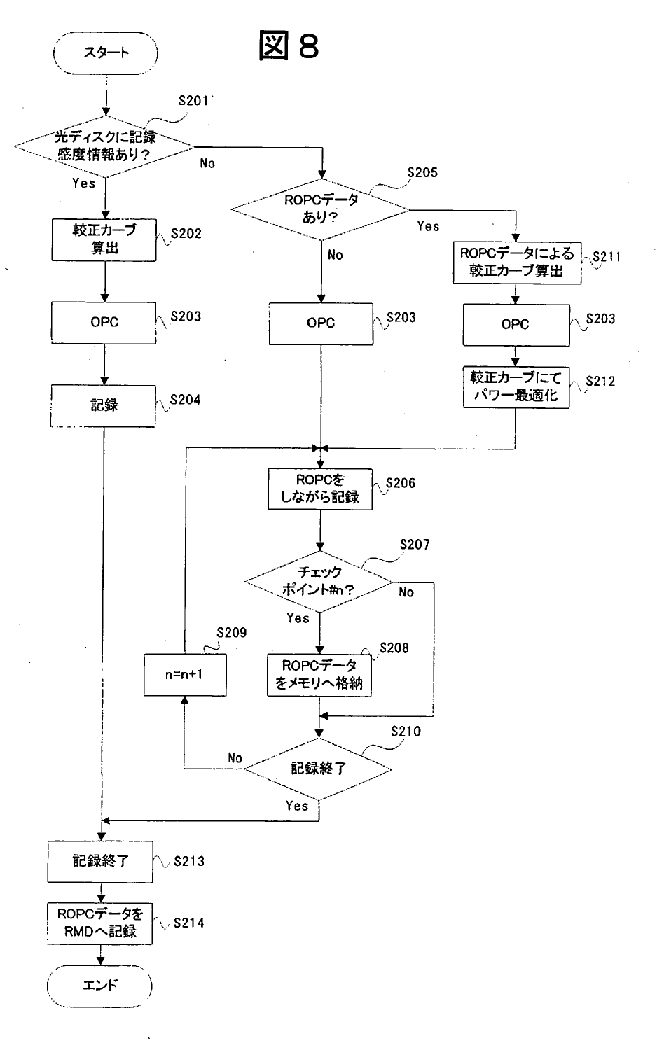

Next, with reference to FIG. 7 to FIG. 16, the second example of the information recording apparatus of the present invention will be discussed. The information recording apparatus in the second example adopts an aspect in which the recording laser power is calibrated at the time of the recording operation of the data and the data is recorded while a result of the calibration is stored as the calibration data of the recording laser power. Incidentally, the same configuration as that of the above-mentioned information recording apparatus in the first example carries the same numerical reference and the same step number, and the detailed explanation thereof is omitted.

(1) Basic Structure

At first, with reference to FIG. 7, the basic structure of the information recording apparatus in the second example will be discussed. FIG. 7 is a block diagram conceptually showing the basic structure of the information recording apparatus in the second example.

As shown in FIG. 7, an information recording apparatus 1 in the example is provided with: the spindle motor 301; the optical pickup 310; the head amplifier 311; the RF detector 312; the servo circuit 315; the LD driver 320; the wobble detector 325; the LPP data detector 326; the envelope detector 330; the OPC pattern generator 340; the timing generator 345; the data collector 350; the buffer 360; the DVD modulator 370; the data ECC generator 380; the interface 390; the CPU 400; a comparison device 410; and a memory 420.

Particularly in the information recording apparatus in the second example, the comparison device 410 is constructed to compare the intensity of reflected light of the light beam B at the time of the recording operation, with the intensity of the reflected light at the time of the above-mentioned OPC operation, in order to perform so-called running OPC.

Here, the running OPC is calibration of the recording laser power, performed in parallel with the recording operation of the data. More specifically, it compares the intensity of the reflected light of the light beam B upon the data recording operation, with the intensity of the reflected light of the light beam B at the time of the OPC operation performed in the OPC area on the lead-in area. Then, the recording laser power of the optical pickup 310 is adjusted to eliminate a difference in the intensity of the reflected light (i.e. such that the intensities of the reflected light have the same value).

Then, the comparison device 410 is constructed such that the reflected light detected by the optical pickup 310 is inputted by a not-illustrated beam splitter or the like.

The memory 420 is constructed to store therein data about the calibration of the recording laser power performed by the running OPC (e.g. a calibration value thereof, a ratio of the recording laser power after the calibration or an absolute value of the recording laser power after the calibration, etc.). Then, the data about the calibration can be read, as occasion demands, by the CPU 400, for example. This is also explained in the above-mentioned information recording apparatus 1 in the first example, but the recording-sensitivity information 103 may be recorded into the memory 420 if the recording-sensitivity information 103 is recorded on the optical disc 100.

(2) Operation Principle

Next, with reference to FIG. 8 and FIG. 16, the operation principle of the information recording apparatus in the second example will be explained. Incidentally, the recording operation of the information recording apparatus in the second example is broadly classified into two types, a type of sequential recording and a type of random recording. Thus, in the explanation of the operation principle here, the sequential recording will be explained as a first operation example, and the random recording will be explained as a second operation example.

### First Operation Example

The first operation example will be discussed, with reference to FIG. 8 to FIG. 14. Incidentally, the sequential recording in the first operation example is a method of continuously recording the data, in which the data is recorded along a track from the inner circumferential side to the outer circumferential side, for example, and the data is not recorded by returning in the opposite direction (i.e. from the outer circumferential side to the inner circumferential side).

(1) Basic Operation

At first, with reference to FIG. 8, the basic recording operation of the information recording apparatus in the second example will be explained. FIG. 8 is a flowchart showing a flow of the recording operation.

As shown in FIG. 8, at first, it is judged whether or not the recording-sensitivity information 103 is recorded on the optical disc 100 which is the target of the recording operation (step S201). Specifically, under the control of the CPU 400, the land pre-pit of the optical disc 100 may be read, and the judgment may be performed by judging whether or not there is information corresponding to the recording-sensitivity information 103 in the LPP signal.

As a result of the judgment, if it is judged that the recording-sensitivity information 103 is recorded (the step S201: Yes), the CPU 400 prepares or generates a calibration curve (specifically, a relational expression between the ratio of the optimum recording laser power and the recording position, as shown in FIG. 6(a) and FIG. 6(b), for example) by using the recording-sensitivity information 103 (step S202). Here, the calibration curve may be actually prepared, or even if the calibration curve is not actually prepared, data by which the calibration curve can be prepared may be prepared.

After that, the OPC process is performed (step S203). Then, the data is actually recorded (step S204). Before this recording operation, it is preferable to obtain a more preferable optimum recording laser power according to the recording position of the data, for example, on the basis of the recording laser power obtained by the OPC process and the calibration curve obtained at the step S202, as explained in the operation principle in the first example (refer to the step S103 in FIG. 5). Then, if the recording position to record the data changes, it is preferable to obtain a more preferable optimum recording laser power according to the calibration curve, at each time, and record the data with the optimum recording laser power. Then, if the data is all recorded, the recording is ended (step S213).

Incidentally, at the time of the recording operation at the step S204, the recording laser power may be calibrated, as occasion demands, with performing a running OPC process, as described later. Then, if the calibration by the running OPC process does not match the calibration curve obtained on the basis of the recording-sensitivity information 103, the calibration curve may be corrected on the basis of a result of the calibration performed by the running OPC.

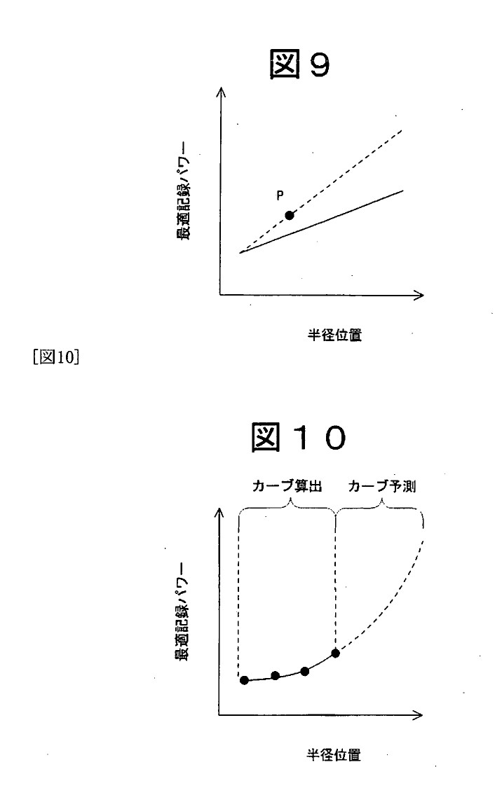

This will be specifically explained, with reference to FIG. 9. FIG. 9 is a graph conceptually showing an aspect of correction of a calibration curve.

It is assumed that the calibration curve of the optimum recording laser power which is obtained by the recording-sensitivity information 103 (and the OPC process) is obtained, as shown in the graph in a thick line in FIG. 9. At this time, it is assumed that the optimum recording laser power in the recording position turns out to have a value at a point P as a result of the running OPC in a predetermined position. At this time, the initial calibration curve shown in the thick line may be corrected to be a calibration curve shown in a dashed line.

In FIG. 8 again, on the other hand, as a result of the judgment at the step S201, if it is judged that the recording-sensitivity information 103 is not recorded (the step S201: No), then, it is judged whether or not ROPC (Running OPC) data is recorded, as being one specific example of the “calibration value” of the present invention (step S205). Specifically, it is judged whether the ROPC data is recorded on the optical disc 100 or in the memory 420, by seeking the optical disc 100 and the memory 420.

Incidentally, the ROPC data is information which indicates a result of the calibration of the recording laser power calibrated by the running OPC process, and it may include the calibration value thereof, or may include the absolute value (or ratio) of the optimum recording laser power. Then, it may also include information about the recording position where the calibration is performed.

As a result of the judgment, if it is judged that the ROPC data is recorded (the step S205: Yes), the calibration curve as being one specific example of the “control information” of the present invention is calculated, on the basis of the ROPC data (step S211). Here, on the basis of the calibration value (or the value and ratio of the optical recording laser power, etc.) included in the ROPC data and the recording position, a relational expression which indicates a relationship between the calibration value and the recording position is prepared by the operation of the CPU 400.

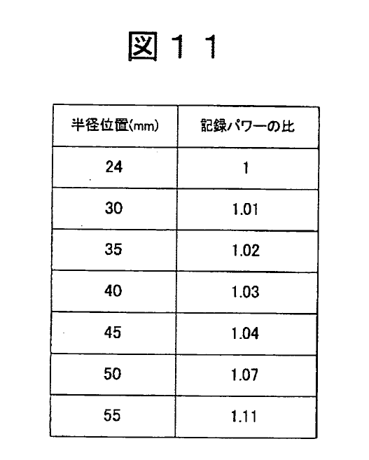

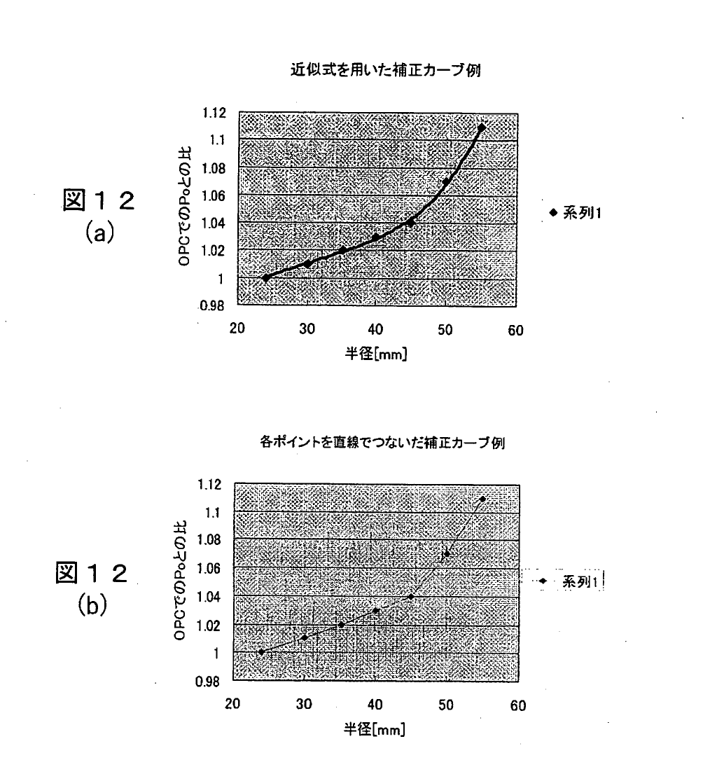

The calculation operation of the calibration curve will be discussed in more detail, with reference to FIG. 10 and FIG. 11. FIG. 10 is a graph conceptually showing an aspect of calculating the calibration curve. FIG. 11 is a list showing one specific example of a more specific calibration curve.

As shown in FIG. 10, it is assumed that a relationship shown with black points is indicated by the ROPC data. Namely, the ROPC data correspond to four recording positions and include the values or ratios of the optimum recording laser powers calibrated by the running OPC in the four recording positions. The CPU 400 uses a mathematical or statistical method, such as a least-squares method, to thereby calculate a curve passing through the four points, from the four points. At this time, it can be said that the curve obtained in the recording positions where the four points exist has high reliability because the calibration performed by the actual running OPC is reflected therein. On the other hand, with regard to the recording position where the running OPC has not been performed yet (i.e. where the ROPC data does not exist), the curve obtained here is merely a predicted value.

However, in the conventional running OPC, since the calibration value or the like of the recording laser power is not recorded, the optimum recording laser power is calculated only in a recording position where the recording is currently performed. However, according to the information recording apparatus 2 in the second example, the calibration value or the like obtained by the running OPC is recorded as the ROPC data, and it is possible to calculate the calibration curve including the optimum recording laser power at the recording position where the recording has not been performed yet, on the basis of the ROPC data. Therefore, as compared to the case in which the recording laser power is calibrated by merely performing the running OPC, there is such a great advantage that the data can be recorded with a more preferable optimum recording laser power.

Incidentally, out of the graph shown in FIG. 10, with regard to a portion of the calibration curve prepared by the prediction, if the actual calibration value or the like in the portion is added to the ROPC data, it can be calculated as a more preferable calibration curve on the basis of the added ROPC data. Moreover, as the ROPC data, it may have the calibration curve itself.

Moreover, such a calibration curve can be prepared if there is the ROPC data including at least two calibration values. For example, a linear line passing through two points shown by the two calibration values may be estimated as the calibration curve. It is obvious that as the number of calibration values included in the ROPC data is greater, the calibration curve with higher reliability is obtained.

Moreover, even without the prediction of the calibration curve as shown in FIG. 10, it is also possible to obtain the optimum recording laser power, by using the ratio or the like of the optimum recording laser power corresponding to the closest (or relatively close) recording position to a recording position of the data. Namely, as shown in FIG. 10, in the recording positions where the calibration curve is obtained by the prediction, the value shown by the black point located at the most right may be set as the value of the optimum recording laser power.

In FIG. 8 again, after the calculation of the calibration curve, the OPC process is performed (the step S203). Then, a more preferable optimum recording laser power is obtained, on the basis of the value of the recording laser power obtained by the OPC process and the calibration curve obtained at the step S202, as explained with reference to the above-mentioned step S103 in FIG. 5 (step S212). Then, after that, the data is recorded while the running OPC is performed (step S206).

On the other hand, as a result of the judgment in the step S205, if it is judged that there is no ROPC data, the OPC process is performed, to thereby obtain the recording laser power (the step S203). After that, the data is recorded while the running OPC is performed (step S206).

Now, the running OPC process is explained. Upon the recording of the data, a pit which indicates the data is formed by irradiating the recording surface of the optical disc 100 with the light beam B. Then, upon the recording of the data, the irradiated light beam B is reflected on the recording surface or the like, and it returns to the optical pickup 310 as reflected light. In the running OPC, the reflected light is used to obtain the optimum recording laser power in the recording position where the data is being recorded. Specifically, the LD driver 320 drives a semiconductor laser, under the control of the CPU 400, such that the intensity of the reflected light is equal to or substantially equal to the intensity of the reflected light at the time of the OPC process at the step S203 in FIG. 8.

Therefore, in the information recording apparatus in the second example, the intensity of the reflected light at the time of the OPC process performed at the step S203 is recorded in the memory 420 or the like, for example. Then, by inputting the intensity of the reflected light into the comparison device 410, it can be compared with the intensity of the reflected light upon the data recording.

Upon the recording at the step S206, the data is recorded while the running OPC is performed. Incidentally, the running OPC process may be continuously performed, or may be performed at predetermined or irregular intervals, or may be performed at each time of arrival at a check point described later.

Here, it is judged whether or not the recording position where the data is being recorded corresponds to a predetermined check point #n (step S207). This check point may be a predetermined radial position (e.g. a radial position of 24 mm, 36 mm, 45 mm, or the like) of the optical disc 100, or may be a predetermined physical address. Alternatively, a point where a linear velocity changes when the data is recorded onto the optical disc 100, may be regarded as the check point, or a point where the recording of the data is stopped (or temporarily stopped) may be regarded as the check point. Then, the radial position may be monitored on the basis of the position of the optical pickup 310. The physical address value may be monitored on the basis of the pre-format address information included in the LPP signal. The radial position may be monitored by estimating the radial position from the physical address value.

Moreover, if it is judged that there is the ROPC data at the step S205, since the data is already recorded in some recording area on the optical disc 100, the information recording apparatus 2 records the data continuously from the area where the data is already recorded. Therefore, with regard to the judgment of whether or not to correspond to the check point #n, it is only necessary to judge whether or not to correspond to the check point #n which exists after the area where the data is already recorded. For example, if there are check points “#1” to “#20” in order, from the inner circumferential side to the outer circumferential side, and if the recording of the data is already ended up to a position beyond the check point “#8”, it is only necessary for the information recording apparatus 2 to judge whether or not to correspond to the check point “#9” to the check point “#20”.

As a result of the judgment, if it is judged that the recording position corresponds to the predetermined check point #n (the step S207: Yes), a result of the running OPC performed in the recording position is recorded into the memory 420 as the ROPC data (step S208). At this time, if the ROPC data already exists in the memory 420, the ROPC data is further recorded so as to add a result of new running OPC. At this time, at the time point that the ROPC data is judged to be recorded at the step S205, this ROPC data may be recorded into the memory 420. Then, it is judged whether or not the recording operation is ended (step S210).

Now, the ROPC data is explained, more specifically, with reference to FIG. 11. FIG. 11 is a list showing one specific example of the ROPC data.

As shown in FIG. 11, in the ROPC data, the recording position and the ratio of the optimum recording laser power in the recording position are recorded. Then, the ratio of the optimum recording laser power is based on an optimum recording laser power in a recording position which is a radial position of 24 mm, in FIG. 11. The ROPC data which is to be recorded into the memory 420 if the recording position corresponds to the check point, is a ratio between one radial position and the optimum recording laser power in the one recording position, out of the ROPC data shown in FIG. 11. Incidentally, even if the ROPC data is not recorded into the memory 420, the ROPC data may be recoded onto the optical disc 100. In particular, in the case of a rewritable type optical disc, since overwriting is possible, even such construction does not influence a recording capacity as the disc.

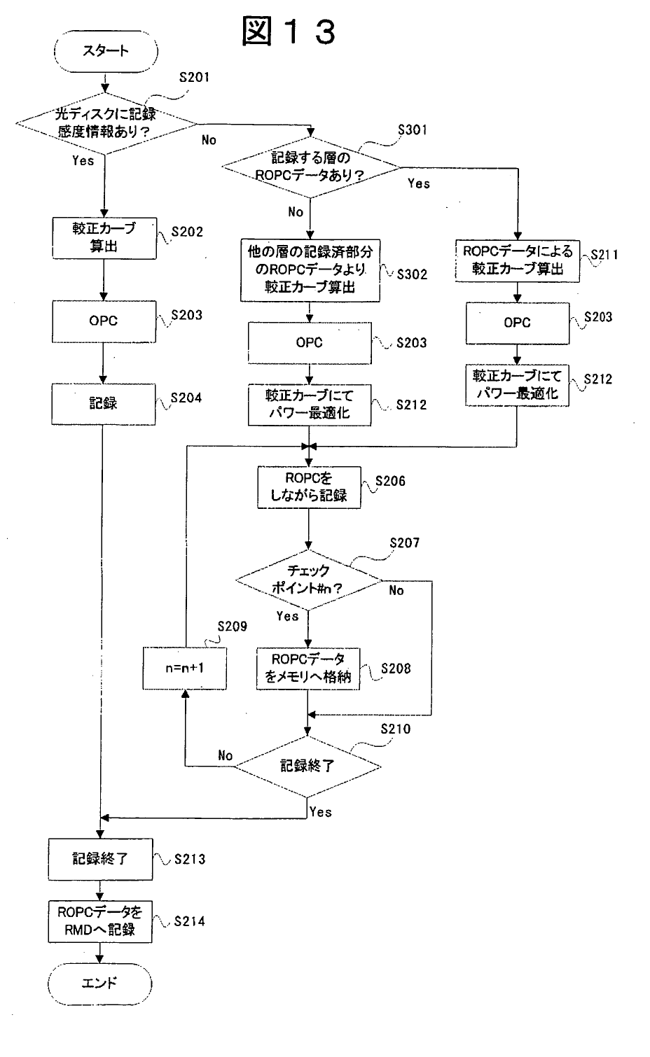

Then, the ROPC data in FIG. 11 is a basis of the calculation of the calibration curve at the step S211 in FIG. 8. For example, calibration curves, as shown in FIG. 12(a) or FIG. 12(b), are calculated on the basis of the ROPC data shown in FIG. 11.

The calibration curve shown in FIG. 12(a) is a function of the ROPC data shown in FIG. 11, obtained by using an approximate expression. The calibration curve shown in FIG. 12(b) is obtained by connecting the ROPC data shown in FIG. 11, in each segment between adjacent two points. Incidentally, the vertical axis is expressed by the ratio of the optimum recording laser power, in which the recording power in the recording position with the radial position of approximately 24 mm is set as a reference value.

In FIG. 8 again, on the other hand, if it is judged that the recording position does not corresponds to the predetermined check point #n (the step S207: No), then, it is judged whether or not the recording operation is ended (step S210). Namely, it is judged whether or not the data to be recorded is all recorded, or whether or not the data is recorded up to a recording capacity limit of the optical disc 100.

As a result of the judgment, if it is judged that the recording operation is ended (the step S210: Yes), the recording operation is ended (step S213). After that, the ROPC data recorded in the memory 420 is recorded into a RMD (Recording Management Data) in the lead-in area 104 of the optical disc 100 (step S214).

On the other hand, if it is judged that the recording operation is not ended (the step S210: No), the variable #n of the check point is incremented (step S209). Namely, a check point which indicates a recording position where the ROPC data is to be recorded next (i.e. a next check point is specified) is updated. Then, the operational flow returns to the step S206 again, and the data is recorded while the running OPC is performed.

Incidentally, the CPU 400 or the like constitutes one specific example of the “controlling device” of the present invention. The “control information preparing device” of the present invention is constructed by including the comparison device 410, the CPU 400, or the like.

(2) Recording into Different Layer

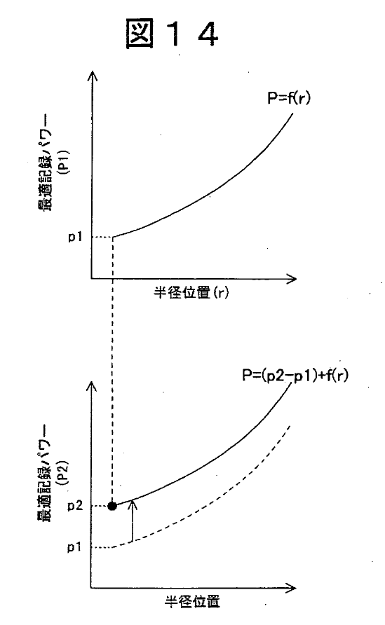

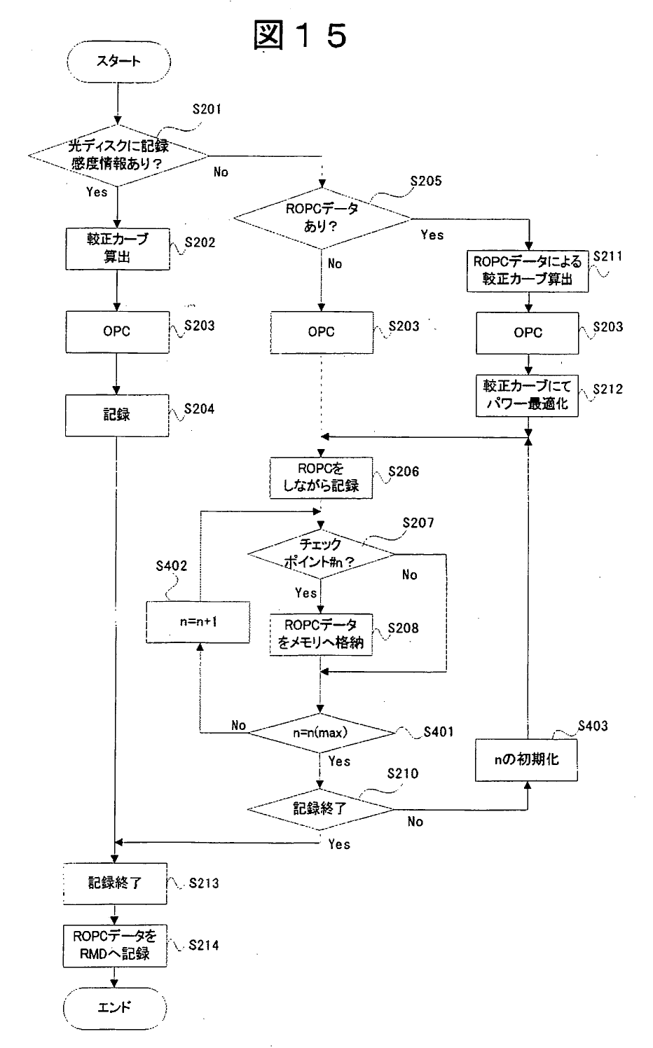

Next, with reference to FIG. 13 and FIG. 14, in the case in which the optical disc 100 has a plurality of recording layers, an explanation will be given to the recording operation when the recording layer which is the target of the recording operation is changed. Incidentally, even in the optical disc having the plurality of recording layers, the recording operation in the case in which the recording into the same recording layer is performed is the same as the operation explained with reference to FIG. 8 to FIG. 12. FIG. 13 is a flowchart showing a flow of the recording operation into the different recording layer. FIG. 14 is a graph conceptually showing the calculation operation of the calibration curve. Incidentally, in FIG. 13, the same operations as those in FIG. 8 carry the same step numbers, and the detailed explanation thereof is omitted.

As shown in FIG. 13, at first, it is judged whether or not the recording-sensitivity information 103 is recorded on the optical disc 100 (the step S201). Here, as the premise of the recording operation, it is assumed that the data is about to be recorded into another recording layer different from the recording layer which has been recorded so far.

As a result of the judgment, if it is judged that the recording-sensitivity information 103 is recorded on the optical disc 100 (the step S201: Yes), as in the operation example in FIG. 8, the calibration curve is calculated (the step S202), the OPC process is performed (the step S203), and the data is recorded (the step S204).

On the other hand, if it is judged that the recording-sensitivity information 103 is not recorded on the optical disc 100 (the step S201: No), then, it is judged whether or not there is the ROPC data in the recoding layer where the data is about to be recorded from now (step S301). Specifically, in the case of an optical disc having two recording layers (i.e. one recording layer and the other recording layer), for example, if the data is about to be recorded into the other recording layer from now, it is judged whether or not the ROPC data in the other recording layer is recorded on the optical disc 100 or in the memory 420 or the like.

As a result of the judgment, if it is judged that the ROPC data is recorded (the step S301: Yes), as in the operation example in FIG. 8, the calibration curve is calculated on the basis of the ROPC data (the step S211), the OPC process is performed (the step S203), and the recording laser power is optimized by using the calibration curve (the step S212). Then, the data is recorded while the running OPC is performed (the step S206).

On the other hand, if it is judged that the ROPC data is not recorded (the step S301: No), the calibration curve is calculated on the basis of the ROPC data in a different recording layer from the recording layer where the data is about to be recorded from now (step S302). For example, in the optical disc having two recording layers (i.e. one recording layer and the other recording layer), if the data is about to be recorded into the other recording layer from now, the calibration curve is calculated by using the ROPC data in the one recording layer. Incidentally, the calculation operation of the calibration curve is performed in the same operation as in the step S211 in FIG. 8.

After that, the OPC process is performed in the recording layer where the data is about to be recorded from now (the step S203). Then, a more preferable optimum recording laser power is obtained on the basis of the value of the recording laser power obtained by the OPC process and the calibration curve obtained in the step S211, as explained with reference to the above-mentioned step S103 in FIG. 5 (the step S212).

Now, the operation of obtaining the optimum recording laser power is explained, with reference to FIG. 14. FIG. 14 is a graph conceptually showing a calibration curve in a difference recording layer.

It is assumed that a calibration curve in one recording layer is shown as in the upper part of FIG. 14. At this time, it is assumed that the calibration curve is expressed by a function expression of P=f(r), wherein the absolute value of the optimum recording laser power is P and the radial position is r. Here, it can be considered that the other recording layer as being the different recording layer has a certain degree of identity in the recording characteristics thereof with the one recording layer, considering the fact that the layers have the same production condition, manufacturer, or the like. Therefore, when the optimum recording laser power in the other recording layer is obtained, it is possible to use the calibration curve in the one recording layer.

Specifically, it is assumed that a recording laser power p2 in the OPC area is obtained in the OPC process in the other recording layer. At this time, as shown in the lower part of FIG. 14, by preparing a calibration curve related to the same rate of change as that of the calibration curve shown in the upper part of FIG. 14, with the p2 as a starting point, it is possible to regard the prepared calibration curve as the calibration curve in the other recording layer. At this time, the calibration curve shown in the lower part of FIG. 14 is expressed by P2=f(r)+(p2·p1), wherein the absolute value of the recording laser power is P2. Of course, even if the calibration curve indicates the ratio of the optimum recording laser power, although the function expression is different, it is possible to obtain the calibration curve in the other recording layer in the same manner as described above. Then, if the ROPC data is obtained as the data is recorded more in the other recording layer, it is preferable to correct the calibration curve to be more highly reliable, by using the ROPC data.

As described above, by preparing the calibration curve in the other recording layer in which the data is about to be recorded from now, with reference to the calibration curve in the one recording layer where the data is already recorded, it is possible to obtain a more preferable optimum recording power in the other recording layer in which the data is not recorded.

In FIG. 13 again, after that, the data is recorded while the running OPC is performed (the step S211). Then, in the same operation as explained in FIG. 8, the data is recorded into the memory 420 at each check point, and the ROPC data is recorded into the RMD after the recording is ended.

### Second Operation Example

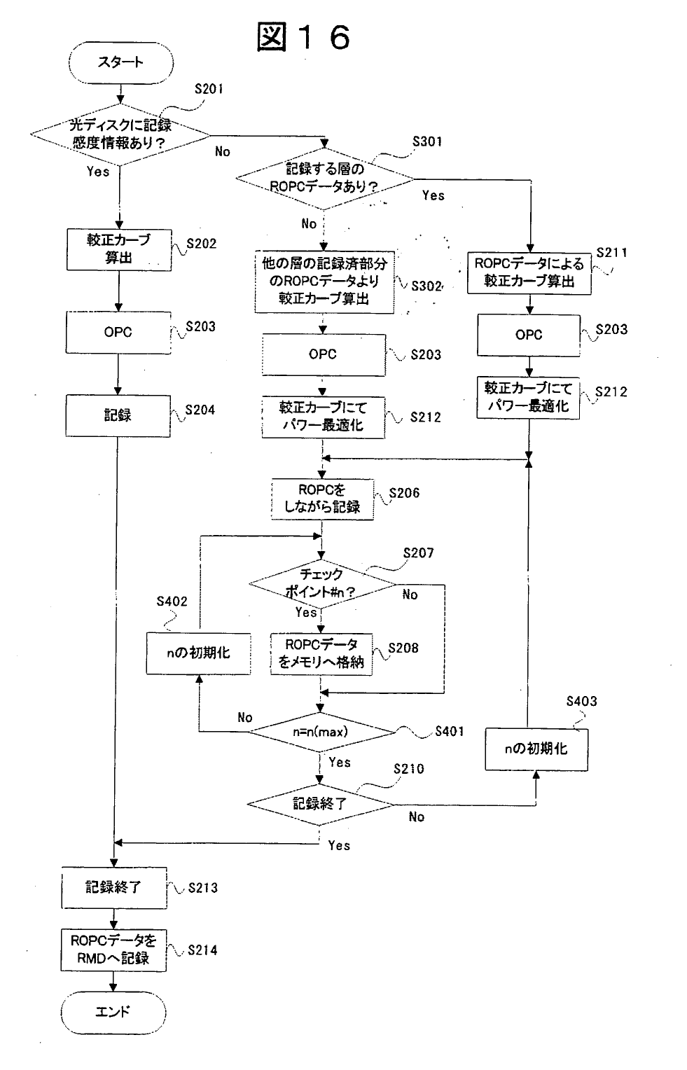

Next, the second operation example will be discussed, with reference to FIG. 15 and FIG. 16. Incidentally, the random recording in the second operation example is a method of recording the data in an arbitrary recording position, in which a direction of the recording operation proceeding is not determined, as opposed to the sequential recording. Incidentally, in FIG. 15 and FIG. 16, the same operations as those in the above-mentioned first operation example carry the same step numbers, and the detailed explanation thereof is omitted.

(1) Basic Operation

At first, with reference to FIG. 15, out of the basic recording operation of the information recording apparatus in the second example, the second operation example will be explained. FIG. 15 is a flowchart showing a flow of the recording operation in the second operation example.

As shown in FIG. 15, the recording operation in the second example is substantially the same as the recording operation related to the first operation example (refer to FIG. 8).

Particularly in the second operation example, the judgment of whether or not to correspond to the check point is different from the first operation example. Specifically, it is judged whether or not the recording position corresponds to the check point #n (the step S207), and if it does, the ROPC data is recorded into the memory 420 (the step S208), and if it does not, it is judged whether or not the recording position corresponds to all the check points (step S401). Namely, if there are the check points #1 to #20, it is judged whether or not a judgment is performed, wherein the judgment is whether or not the recording position with regard to which the judgment is currently performed corresponds to any of the check points #1 to #20. In FIG. 15, n(max) indicates the total number of the check points.

As a result of the judgment, if it is judged that the judgment of whether or not to correspond to all the check points is not performed (the step S401: No), n is incremented (step S402), and judgment of whether or not to correspond to a check point #n+1 is performed. On the other hand, if it is judged that the judgment of whether or not to correspond to all the check points is performed (the step S401: Yes), then, it is judged whether or not the recording operation is ended (the step S210).

As a result of the judgment, if it is judged that the recording operation is ended (the step S210: Yes), the recording is ended (the step S213), and the ROPC data is recorded into the RMD (the step S214).

On the other hand, if it is judged that the recording operation is not ended (the step S210: No), n is initialized (e.g. n=1), and the data is recorded while the running OPC is performed (the step S206).

(2) Recording into Different Layer

Next, with reference to FIG. 16, in the case where the optical disc 100 has a plurality of recording layers, an explanation will be given to the recording operation when the recording layer which is the target of the recording operation is changed. FIG. 16 is a flowchart showing a flow of the recording operation into the different recording layer.

As shown in FIG. 16, the recording operation in the second operation example is substantially the same as that in the first operation example, and also, the judgment of whether or not to correspond to the check point is the same as the operation explained with reference to FIG. 15 described above.

Consequently, according to the information recording apparatus 2 in the second example, it is possible to obtain the optimum recording laser power, relatively easily, by referring to the result of the calibration by the running OPC performed during the data recording. In particular, even as for the optimum recording laser power in the recording position where the data is not recorded, it is possible to obtain (or estimate) a preferable recording laser power from the result of the calibration by the running OPC already performed.

Incidentally, if it is determined in advance that only the calibration by the running OPC is performed, for example, the judgment of the step S201 in FIG. 8 (or FIG. 13, FIG. 15, FIG. 16 or the like) may be omitted, and the recording operation may be started from the judgment operation in the step S205.

Moreover, in the above-mentioned explanation, the explanation to use the calibration curve obtained by the recording-sensitivity information 103 and the explanation to use the calibration curve based on the ROPC data are given; however, it is also possible to obtain a more preferable optimum recording laser power by combining the two calibration curves.

Moreover, in the above-mentioned examples, the optical disc 100 is explained as one example of the information recording medium, and the recorder related to the optical disc 100 is explained as one example of the information recording apparatus. The present invention, however, is not limited to the optical disc and the recorder thereof, and can be applied to other various information recording media and players thereof that support high-density recording or a high transfer rate.

The present invention is not limited to the above-described example, and various changes may be made, if desired, without departing from the essence or spirit of the invention which can be read from the claims and the entire specification. An information recording medium, an information recording apparatus, an information recording method, an information recording/reproducing apparatus, an information recording/reproducing method, and a computer program for recording control and for recording/reproduction control, all of which involve such changes, are also intended to be within the technical scope of the present invention.

### INDUSTRIAL APPLICABILITY

The information recording medium, the information recording apparatus, the information recording method, the information recording/reproducing apparatus, the information recording/reproducing method, and the computer program according to the present invention can be applied to a high-density optical disc in which various information can be recorded at high density, for consumer use or for commercial use, and also applied to a recorder or a player or the like associated with the optical disc. Moreover, they can be applied to a recording or reproducing apparatus or the like which is mounted on various computer equipment for consumer use or for commercial use, or which can be connected to various computer equipment.

1. An information recording medium comprising:
a recording area to record therein record information by irradiating laser light thereto; and
a recording control area to record therein control information for controlling a laser power in accordance with a recording position in said recording area.

2. The information recording medium according to claim 1, wherein the control information indicates an association between information which represents the recording position in said recording area and information which represents recording sensitivity in the recording position.

3. The information recording medium according to claim 1, wherein the control information indicates an association between information which represents the recording position in said recording area and information which represents an optimum laser power in the recording position.

4. The information recording medium according to claim 1, wherein the control information indicates a correlation relationship between the recording position in said recording area and an optimum laser power in the recording position.

5. An information recording apparatus comprising:
a recording device for recording record information by irradiating laser light onto said information recording medium according to claim 1; and
an optimizing device for optimizing a laser power, on the basis of the control information recorded in said recording control area of said information recording medium.

6. The information recording apparatus according to claim 5, wherein said optimizing device roughly estimates the control information at a recording position for which the corresponding control information does not exist, on the basis of the control information recorded in said recording control area.

7. An information recording apparatus comprising:
a first recording device for irradiating laser light onto an information recording medium and for recording record information onto said information recording medium;
a control information generating device for obtaining an optimum laser power according to a recording position of said information recording medium and for generating control information which indicates an association between information which represents the recording position and information which represents the optimum laser power;
a second recording device for recording the control information generated by said control information generating device; and
a controlling device for controlling a laser power of the laser light irradiated onto said information recording medium, on the basis of the control information recorded by said second recording device.

8. The information recording apparatus according to claim 7, wherein said second recording device records the control information generated by said control information generating device, onto said information recording medium.

9. The information recording apparatus according to claim 7, wherein said control information generating device generates the control information, on the basis of a calibration value of a laser power obtained by performing running OPC (Optimum Recording Calibration).

10. The information recording apparatus according to claim 7, wherein said control information generating device generates the control information corresponding to each predetermined area of said information recording medium.

11. The information recording apparatus according to claim 7, wherein said control information generating device generates the control information corresponding to a recording linear velocity of said information recording medium.

12. The information recording apparatus according to claim 7, wherein
said information recording medium comprises a plurality of recording layers, and
said controlling device controls the laser power irradiated to another recording layer, on the basis of the control information obtained in one recording layer, in a case in which a target, to which said recording device performs recording operation, is changed from the one recording layer to the another recording layer out of the plurality of recording layers.

13. The information recording apparatus according to claim 7, wherein
said information recording medium comprises a plurality of recording layers, and
said control information generating device generates the control information in another recording layer, on the basis of the control information obtained in one recording layer, in a case in which a target, to which said recording device performs recording operation, is changed from the one recording layer to the another recording layer out of the plurality of recording layers.

14. An information recording method comprising:
a recording process of recording record information by irradiating laser light onto said information recording medium according to claim 1; and
an optimizing process of optimizing a laser power, on the basis of the control information recorded in said recording control area of said information recording medium.

15. An information recording method comprising:
a first recording process of irradiating laser light onto an information recording medium and of recording record information onto said information recording medium;
a control information generating process of obtaining an optimum laser power according to a recording position of said information recording medium and of generating control information which indicates an association between information which represents the recording position and information which represents the optimum laser power;
a second recording process of recording the control information generated in said control information generating process; and
a controlling process of controlling a laser power of the laser light irradiated onto said information recording medium, on the basis of the control information recorded in said second recording process.

16. An information recording/reproducing apparatus comprising:
said information recording apparatus according to claim 5; and
a reproducing device for reproducing the record information recorded on said information recording medium.

17. An information recording/reproducing apparatus comprising:
said information recording apparatus according to claim 7; and
a reproducing device for reproducing the record information recorded on said information recording medium.

18. An information recording/reproducing method comprising:
said information recording method according to claim 14; and
a reproducing process of reproducing the record information recorded on said information recording medium.

19. An information recording/reproducing method comprising:
said information recording method according to claim 15; and
a reproducing process of reproducing the record information recorded on said information recording medium.

20. A computer program for record control to control a computer provided for the information recording apparatus according to claim 5, to make the computer function as at least one portion of said recording device and said optimizing device.

21. A computer program for record control to control a computer provided for the information recording apparatus according to claim 7, said computer program making the computer function as at least one portion of said recording device, said control information generating device, said second recording device, and said controlling device.

22. A computer program for record/reproducing control to control a computer provided for the information recording/reproducing apparatus according to claim 18, said computer program making the computer function as at least one portion of said information recording apparatus and said reproducing device.

23. A computer program for record/reproducing control to control a computer provided for the information recording/reproducing apparatus according to claim 19, said computer program making the computer function as at least one portion of said information recording apparatus and said reproducing device.
